(19) United States
(12) Patent Application Publication
(10) Pub. No.: US 2011/0283851 A1
(43) Pub. Date: Nov. 24, 2011

(54) Method and hot forming system for producing press-hardened formed components of sheet steel

(75) Inventors: Jens Overrath, Wunstorf (DE); Oliver Straube, Blankenfelde (DE); Jean-Jacques Lety, Bouville (FR); Stéphane Anquetil, Mareil Sur Mauldre (FR)

(73) Assignees: THYSSENKRUPP SOFEDIT S.A.S., Saint-Quentin-en-Yvelines (FR); THYSSENKRUPP UMFORMETECHNIK GMBH, Ludwigsfelde (DE)

(21) Appl. No.: 12/784,956

(22) Filed: May 21, 2010

(51) Int. Cl. B26D 7/10; B21D 28/00

(52) U.S. Cl. 83/15; 83/170

(57) ABSTRACT

The invention relates to a method and to a hot forming system for producing press-hardened formed components of sheet steel, comprising a furnace (8) by means of which sheet steel which is to be hot formed, can be at least partially heated to austenitization temperature, and comprising a press system (10) for hot forming and press-hardening of the sheet steel heated in the furnace. To make it possible to use available pressing capacities and to reach a high number of strokes and thus a high productivity, the invention provides for a heating device (7) to be arranged upstream of the furnace (8), by means of which the sheet steel (2) can be at least partially heated to a temperature of below the austenitization temperature, preferably to a temperature in the range of from 500 to 700° C., and for the press system (10) to be embodied in a multi-stage manner, wherein a first part (10.1) of the press system (10) comprises at least a first tool for hot forming and for cooling the sheet steel, which is heated in the furnace (8), and for a subsequent part (10.2) of the press system (10) to comprise at least a second tool for further cooling the hot formed sheet steel, and wherein the second tool further forms, cuts and/or punches the hot formed sheet steel.

The invention relates to a hot forming system for producing press-hardened formed components of sheet steel, comprising a furnace, by means of which sheet steel which is to be hot formed can be at least partially heated to austenitization temperature, and a press system for hot forming and press-hardening the sheet steel which is heated in the furnace. The invention further relates to a method for producing press-hardened formed components of sheet steel, wherein sheet steel is at least partially heated to austenitization temperature in a furnace, is subsequently hot formed by means of a press system and is cooled down by means of a cooling device.

Typically, special hot forming systems which substantially consist of a furnace system and a press, in some cases also of a multi-ram press, are used for the press-hardening of high-tensile car body components. Typically, the presses are hydraulic presses, because relatively long closing times have to be realized. So as to increase the performance of the hot forming system in spite of the associated slow clock cycles of 2 to 3 strokes per minute, for example, a plurality of parts are formed and press-hardened simultaneously per press stroke on hot forming lines known to the applicant. Presently, a cutting of hot formed components typically takes place in a separate laser process step or in a separate cutting line, wherein the components are discharged from the hot forming line and are guided back into the hot forming line again after the cutting. This is very labor-intensive and is unfavorable from an economical point of view, which is why solutions for how to be able to combine the processes press-hardening and cutting in one production line are sought.

In the construction of motor vehicles, the trend can be observed that considerable quantities of body parts, which were produced by means of cold forming until now, are replaced with hot formed components, in particular with press-hardened components.

The present invention is based on the object of providing a hot forming system or a method of the afore-mentioned type, respectively, which provides for the use of available press capacities, which allows for a high number of strokes and which thus yields a high productivity.

This object is solved by means of a hot forming system comprising the features of claim 1 or by means of a method comprising the features of claim 18, respectively.

The hot forming system according to the invention comprises a furnace, by means of which the sheet steel which is to be hot formed is at least partially heated to austenitization temperature, and a press system for hot forming and press-hardening the sheet steel which is heated in the furnace. According to the invention, a heating device is arranged upstream of the furnace, by means of which the sheet steel can at least be partially heated to a temperature below the austenitization temperature, preferably to a temperature in the range of from 500 to 700° C. The press system is here embodied in multiple stages, wherein a first part of the press system comprises at least a first tool for hot forming and cooling the sheet steel heated in the furnace, and a subsequent part of the press system comprises at least a second tool for further cooling the hot formed sheet steel, and wherein the second tool further forms, cuts and/or punches the hot formed sheet steel.

The method according to the invention for producing press-hardened formed components of sheet steel is accordingly characterized in that, prior to the heating in the furnace, the sheet steel is at least partially heated to a temperature below the austenitization temperature, preferably to a temperature in the range of from 500 to 700° C. by means of a heating device and in that the cooling of the hot formed sheet steel is carried out in multiple stages, wherein the sheet steel heated in the furnace is hot formed and cooled down in a first part of the press system and is afterwards further cooled down in a subsequent part of the press system, and wherein the hot formed sheet steel is additionally further formed, cut and/or punched in the subsequent part of the press system.

By means of the heating device which is arranged upstream of the furnace a quick preheating of the sheet steel which is to be hot formed, or of a corresponding blank, respectively, can be carried out so that the furnace for heating the blank to austenitization temperature itself can be embodied so as to be relatively short and thus requires a correspondingly small amount of space. The length of the furnace lies in the range of from 10 m to 20 m, for example, and is preferably approximately 10 m or less. Due to the relatively small space requirement of the furnace and of the assigned heating device, the system according to the invention is capable of being set up in an existing production hall without problems. A new construction of a hall is thus not necessary for the most part. Advantageously, the furnace consists of a continuous furnace, preferably a roller hearth furnace. To be able to embody the furnace section, that is, the length of the furnace, as short as possible, the furnace is preferably provided with at least one inductive heating device and/or at least one infrared radiator.

The combination according to the invention of an austenitization furnace with a heating device, which is arranged upstream, furthermore provides the opportunity to reduce the required energy input for heating the blanks to austenitization temperature. In particular, this combination provides the opportunity of a selective heating of certain areas of the blank in the heating device, so that one or a plurality of certain areas of the respective blank are not transferred into the austenitization state during the subsequent furnace passage and thus comprise lower strengths values after the cooling step than the areas which have been transferred into the austenitization state. These less solid or hard areas, respectively, are better suited for a later cutting. These areas are furthermore not or considerably less sensitive with reference to a delayed fissuring.

In this preferred embodiment of the invention, the method according to the invention thus provides for the sheet steel or for the respective blank, respectively, to be partially heated in the heating device or to a different degree in partial areas. In particular, the invention proposes for the sheet steel to be supplied to the heating device as cut blank and for the blank not to be heated directly and/or tempered at least in a partial area, in which a cutting and/or a punching is carried out subsequently, such that this at least one partial area is not transferred into the austenitization state in response to the subsequent heating in the furnace.

A high number of strokes and thus a high productivity are made possible in the case of the hot forming system according to the invention in particular by means of the multi-stage embodiment of the press system. According to the invention, the respective blank, which is partially transferred into the austenitization state, is formed for the most part in the first part of the press system and is there cooled down to a temperature range of preferably approx. 700° to 500° C., particularly preferably to approximately 600° C. for the press-hardening. In the subsequent part of the press system, the hot formed component is then still slightly further hot formed and calibrated and is cooled down to a temperature range of preferably approx. 300° to 200° C., particularly preferably to approx. 200° C., and is cut and/or punched in one or a plurality of partial areas.

Higher component strength can be reached, in particular, by means of the multi-stage, preferably two-stage embodiment of the press system. Due to the at least two-stage hot forming and cooling process, in which the major portion of the hot forming is carried out in the first part, that is, in the first stage of the press system, an improved fit can be attained in the second or in a subsequent part of the press system, respectively, comprising a considerably increased contact surface between component and cooling tool, thus resulting in an improved cooling and thus an increased component strength.

According to a preferred embodiment of the hot forming system according to the invention, the heating device thereof comprises heating plates which can be moved relative to one another and which can be placed or pressed against a sheet steel, which is arranged therebetween and which is to be heated. The heat transfer is a function of the pressure of the heating plates and is preferably applied either by means of a hydraulic, a mechanical press or a press-like device.

To be able to quickly and cost-efficiently heat a chosen partial area of the sheet steel, which is to be hot formed, to a predeterminable temperature, the heating plates of the heating device are preferably embodied as electrically or inductively heated heating plates. The heat energy costs can in particular be reduced with the use of inductively heated heating plates.

Instead of heating plates which are brought into contact with the sheet steel or the blank, respectively, the heating device of the hot forming system according to the invention can also comprise a surface inductor or ring inductor heating unit, which operates in a contact-free manner.

A further preferred embodiment of the hot forming system according to the invention is that at least one mechanically or hydraulically driven device for cutting and/or punching the hot formed, press-hardened sheet steel is arranged downstream from the multi-stage press system. The component can thus be punched or cut, respectively, within narrow tolerances, and this preferably in the room temperature state. This is so, because according to experience, dimensionally accurate holes as well as a dimensionally accurate edge trim in the warm state of the component can often not be obtained in the desired quality.

For the hard cutting of the hot formed components, the concept according to the invention allows for the use of conventional mechanical or hydraulic presses from available forming systems, in particular from cold forming systems.

Preferably, the cutting device which is arranged downstream from the press system is in the form of a toggle press, which is provided with at least one cutting and/or punching tool (hard cutting tool). Toggle presses can transfer high cutting forces at an adapted speed during cutting. Preferably, the toggle presses of the hot forming system according to the invention are embodied as stiff toggle presses. With regard to the cutting quality as well as to a disruption-free operation of the cutting device (toggle press), it is advantageous when it is embodied with at least one cutting impact shock absorber according to a further preferred embodiment.

According to a further advantageous embodiment, provision is made for a cooling device to be arranged between the press system and the cutting device, by means of which the hot formed and at the same time highly cooled sheet steel can be cooled down further by means of a liquid, in particular by means of water, oil or an emulsion. The component is thereby preferably cooled to room temperature. Preferably, this cooling device comprises an immersion tank for this purpose. In the event that oil or an emulsion is used in the cooling device as cooling agent or as immersion bath, respectively, the subsequent hard cutting is facilitated and the cutting result is improved. In particular, the wear on the subsequent cutting tool or cutting tools, respectively, is reduced by oiling the component or by dipping it into an emulsion, respectively.

In a further embodiment of the hot forming system according to the invention, provision is made in each case for an automatically controlled transfer device, preferably a robot, for transferring the blank or the component, respectively, from the heating device to the furnace and/or from the furnace to the press system and/or from the press system to a cutting device arranged downstream. The transfer device arranged between the heating device and the furnace and/or the transfer device arranged between the furnace and the press system can be provided with a heating device so as to prevent a (premature) cooling of the heated blank.

In the case of the method according to the invention, manganese-boron sheet steel is preferably used to produce the press-hardened formed components and prediffused manganese-boron sheet steel (AlSi-22MnB5) is used particularly preferably. The latter can be generated in a steel works which is equipped accordingly, by means of continuous annealing. Even though the material costs for prediffused manganese-boron sheet steel are higher than the material costs for untreated manganese-boron sheet steel, prediffused manganese-boron sheet steel provides the advantage over untreated manganese-boron sheet steel that the prediffused sheet steel can be transferred into the austenitization state much more quickly, so that the furnace section required for this purpose can be dimensioned so as to be correspondingly shorter. In response to the use of prediffused manganese-boron sheet steel, the austenitization furnace can thus be embodied to be very short.

A further preferred embodiment of the method according to the invention is characterized in that partial areas of the sheet steel or of the component, respectively, in the first part of the press system and/or in the subsequent part of the press system are cooled at different rates, wherein at least one partial area, in which a cutting and/or a punching is carried out subsequently, is cooled down at a lower cooling rate than a partial area, in which neither a cutting nor a punching is carried out subsequently. The partial area, in which a cutting and/or a punching is carried out subsequently, is here preferably cooled down at a cooling rate of below 27 K/s. The corresponding partial area thus attains low strength values, so that it is more suitable for the hard cutting.

Further preferred and advantageous embodiments of the hot forming system according to the invention and of the method according to the invention are specified in the dependent claims. The invention will be described below in more detail with respect to a drawing, which illustrates a plurality of exemplary embodiments. In schematic illustration:

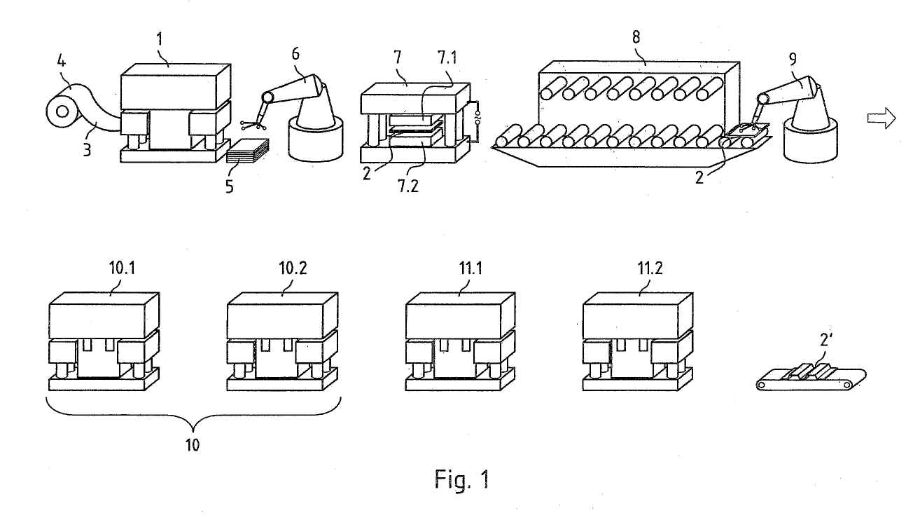

FIG. 1 shows a hot forming system according to a first exemplary embodiment;

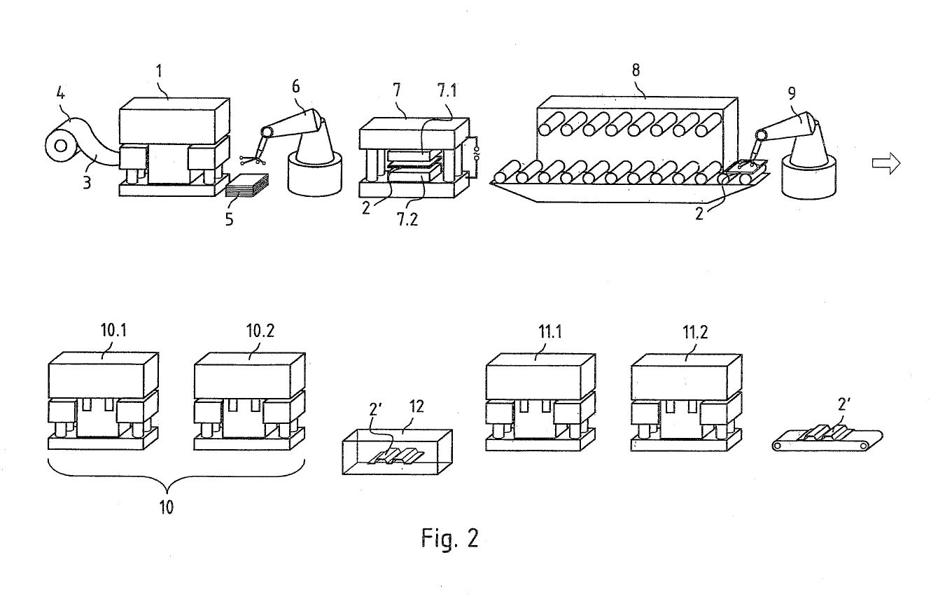

FIG. 2 shows a hot forming system according to a second exemplary embodiment;

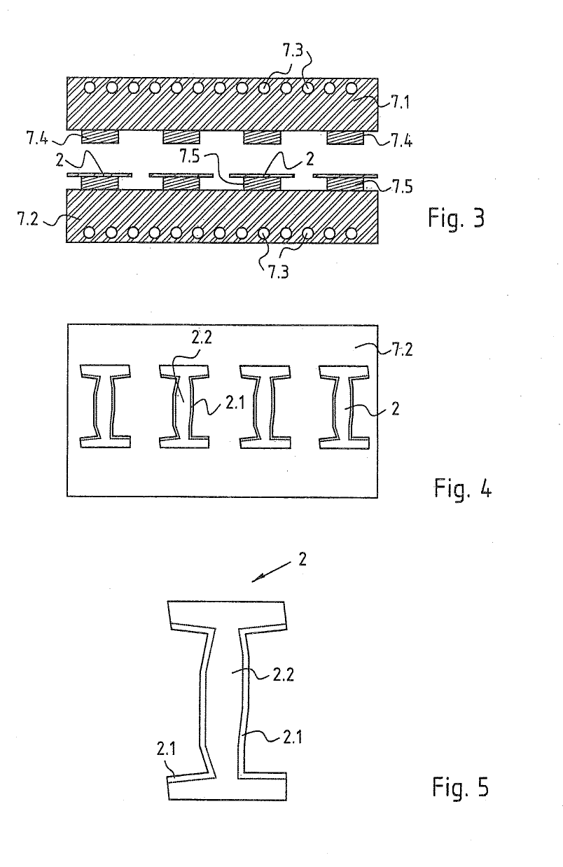

FIG. 3 shows a heating device implemented in the hot forming system of FIG. 1 as well as of FIG. 2 in an enlarged illustration;

FIG. 4 shows a lower heating plate of the heating device with blanks stored thereon in top view;

FIG. 5 shows a single blank in top view;

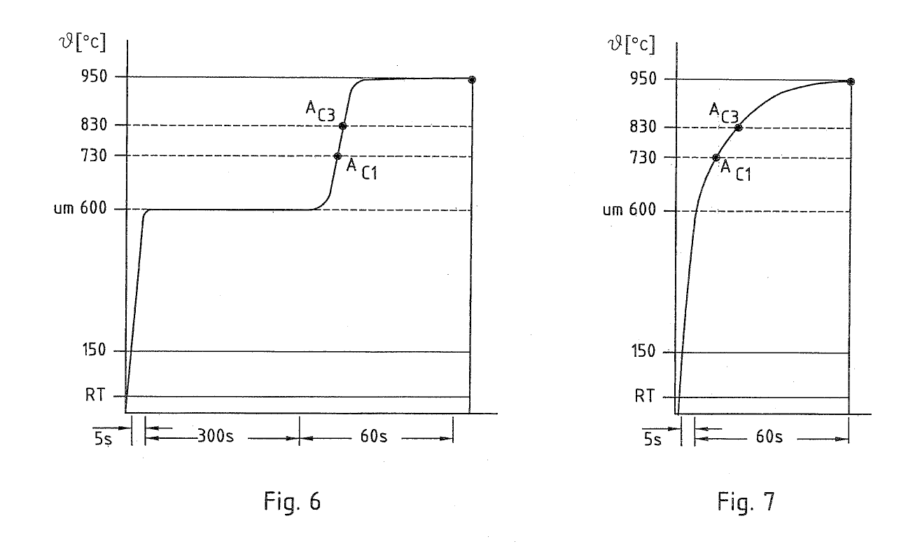

FIG. 6 shows a temperature course for an area of an untreated manganese-boron sheet steel, which is to be transferred into the austenitization state;

FIG. 7 shows a temperature course for an area of a prediffused manganese-boron sheet steel, which is to be transferred into the austenitization state; and

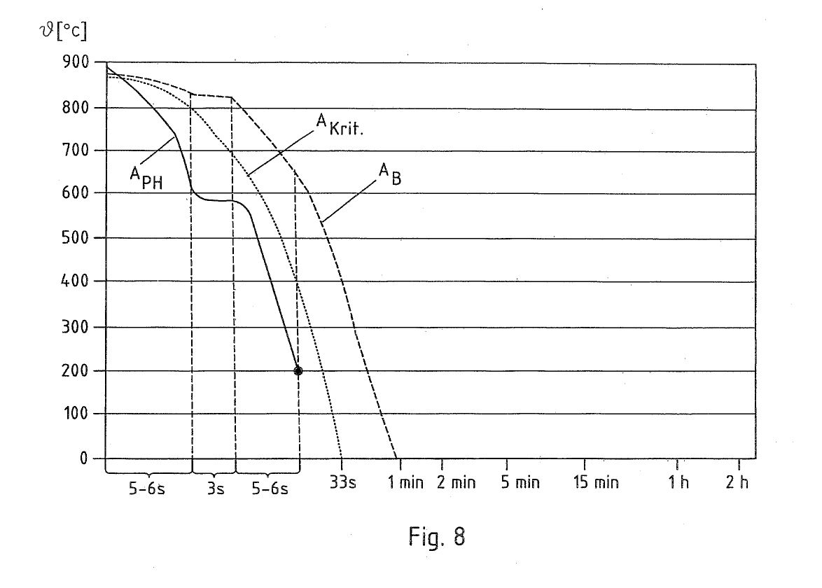

FIG. 8 shows a time-temperature diagram (cooling diagram) in which a critical minimum cooling curve, a time-temperature curve for a press-hardening of formed components during the hot forming and a time-temperature curve for cutting areas of the formed components, which are not transferred into the martensite state, are plotted.

The hot forming system illustrated in FIG. 1 serves the purpose of producing press-hardened formed components 2′ from sheet steel, for example chassis arms or side impact beams for motor vehicle doors. Other examples are bumper brackets, B columns, A columns and roof frames. The hot forming system comprises a punching press 1 for cutting blanks 2 from a sheet steel strip 3. The steel strip 3 consists of manganese-boron steel, preferably of manganese-boron sheet steel (AlSi-22MnB5) which is prediffused by means of continuous annealing. It is supplied as a coil 4 by an unwinding device to the punching press 1, which operates with a high number of strokes. The blanks 2 are deposited on a stack 5, which serves as a buffer, from where they are supplied to a heating device 7 by means of a robot 6 or by means of another suitable transfer device, and they are placed into said heating device 7, before they finally reach into a continuous furnace 8.

The heating device 7 according to the invention comprises a heated tool, which is preferably composed of two heating plates 7.1, 7.2 which can be moved relative to one another. The tool or the heating plates 7.1, 7.2, respectively, are heated electrically, by means of gas, or inductively. The heated plates are guided in a guide frame and are pressed against one another with the blank 2 arranged therebetween.

In the exemplary embodiment illustrated in FIG. 3, heating rods 7.3 are integrated in the heating plates 7.1, 7.2, which can be moved relative to one another. On the sides facing one another, the heating plates 7.1, 7.2 are provided with a plurality of heating molds 7.4, 7. 5, which project from the respective heating plate 7.1, 7.2, wherein the heating molds 7.4, 7.5 of the receptive heating plate are arranged so as to be spaced apart from one another. The heating molds 7.4, 7.5 of the upper and lower heating plate 7.1, 7.2, which are located opposite one another form a plurality of pairs of heating molds 7.4, 7.5, which cover one another.

In the open state of the heating device, a blank 2 is placed in each case onto the lower heating molds 7.5. With reference to the blanks 2, the heating plates 7.1, 7.2 or molds 7.4, 7.5, respectively, are embodied such that the areas which are to be cut later or the edges 2.1 of the blanks 2 placed thereon, respectively, are not directly heated by contact with the heating plates 7.4. 7.5 in the closed state of the heating device 7. Through this, different heating states can be reached in the respective blank 2, so that a certain area 2.1 of the blank 2 is not transferred into the austenitization state by the further heating in the furnace 8, which is located downstream.

For quickly heating the blanks 2, the heating plates 7.1, 7.2 are pressed against one another mechanically or hydraulically with the blanks 2 arranged therebetween. The higher the pressure, the higher the heating rate. The heating plates 7.1, 7.2 can be heated to a temperature level of from 500° to 700° C., preferably up to 600° C. The temperature in the heating plates 7.1, 7.2 is set such that, starting at 500° C., a heating rate of 12 K/s is not exceeded. At the end of the heating in the heating device, an area 2.2 of the blank 2 which is to be transferred subsequently into the austenitization state in the furnace 8, has an average temperature of 750° C., for example, whereas the edge of the blank 2.1 or the area of the blank 2, respectively, which is not to be transferred into the austenitization state, has an average temperature of approximately 450° C., for example.

The blank 2 which comprises different temperature ranges is then transferred out of the heating device into the furnace 8. Preferably, this also takes place by means of a robot or by means of another suitable transfer device (not shown).

Preferably, the furnace 8 is embodied as a continuous furnace, for example as a roller hearth furnace or a walking beam furnace. It has a length in the range of approximately 10 to 20 m and is equipped with at least one inductive heating device and/or with at least one infrared radiator.

The length of the continuous furnace 8 depends on the condition of the sheet steel 3 which is used for producing the formed components 2′. When using untreated manganese-boron sheet steel, the blanks 2 cut therefrom are initially heated in the furnace 8 such that the area 2.2 of the respective blank 2, which is to be transferred into the austenitization state, comprises an alloying temperature over a period of approximately 300 seconds, and such that an alloying of the surface of the blanks thus takes place in this area 2.2. In the case of untreated manganese-boron sheet steel, the alloying temperature is typically in a temperature range of about 600° C. (see FIG. 6). Subsequently, the blanks 2 are heated in the furnace 8 over a period of approximately 60 seconds to austenitization temperature or to a temperature above the austenitization temperature, respectively. In the case of the used manganese-boron sheet steel, the lower transition point A_{C1}, at which the transition from ferrite into austenite takes place, lies at approx. 730° C. In the case of the illustrated example, the upper transition point A_{C3}, at which the transition into austenite ends, lies at approx. 830° C.

To ensure a reliable austenitization of the blank area 2.2 which is to be transferred into the austenitization state, as well as the reliable press-hardening thereof by means of a quick cooling to below the critical cooling curve, the blanks 2 are heated in the furnace 8 to a temperature of considerably above the transition point A_{C3}. For example, the temperature of the blank area 2.2, which is transferred into the austenitization state for the subsequent press-hardening, lies at approx. 950° C. when removing them from the furnace 8 (see FIG. 6).

Preferably, manganese-boron sheet steel AlSi-22MnB5, which is prediffused by means of annealing, is used as coil material (base material) 4 in the case of the hot forming method according to the invention. Even though this prediffused material causes higher prematerial costs, it provides the opportunity of embodying the continuous furnace 8 to be very short, because the alloying through of the surface of the blank area 2.2, which is to be transferred into the austenitization state, which requires a relatively large amount of time, does not need to be carried out anymore in this case. FIG. 7 illustrates that only the heating to a temperature of above the austenitization temperature must be carried out in the continuous furnace 8 when using prediffused manganese-boron sheet steel (AlSi-22MnB5), which can be carried out in a relatively short amount of time. The temperature of the blank area 2.2 which is transferred into the austenitization state for the subsequent press-hardening, when removed from the furnace 8, is again approx. 950° C. in this case. This partial austenitization can be reached in approx. 60 to 65 seconds, so that the furnace section can be embodied so as to be relatively short. In this case, the length of the continuous furnace 8 can be only approximately 10 m or less, for example.

The blank 8 heated in such a manner is then removed from the furnace 8 by means of a robot or by means of another quick transfer device and is placed into the first part 10.1 of a press system 10, which is embodied in two stages, for hot forming and simultaneous press-hardening. The first stage or station 10.1 of the press system 10 consists of a mechanical or hydraulic press. Preferably, a hydraulic press comprising a press capacity of, for example, approximately 1000 t or approx. 10 MN, respectively, is used. The press 10.1 forming the first part of the press system 10 is equipped with a cooled forming tool. The largest part of the hot forming operation takes place in the first press 10.1, wherein the resulting formed component is cooled down from approx. 900° C. to a temperature range of approx. 700° to 500° C., preferably to 600° C., in a period of only approx. 5 to 6 seconds. The cooling rate in the first stage 10.1 thus approximately lies in the range of from 80 to 33.3 K/s and thus in any case considerably above a critical cooling rate of 27 K/s.

In the subsequent part or the second stage 10.2 of the press system 10, respectively, the formed component is cooled down further, is further formed to a small extent and is calibrated. The second stage (station) 10.2 of the press system also consists of a mechanical or hydraulic press. Preferably, the second stage 10.2 is a hydraulic press comprising a press capacity of, for example, approximately 800 t or approx. 8 MN, respectively. In addition to the hot forming and cooling of the component, it is also cut or punched, respectively, in the second stage 10.2 of the press system.

The closing time of the presses 10.1 and 10.2 can be variably set.

A quick transfer device between the two stations 10.1 and 10.2 of the press system 10 is important so as to keep the interruption of the press-hardening process which requires a quick cooling by the transfer from the tool of the first press 10.1 into the tool of the second press 10.2 as brief as possible. Preferably, a robot or another quick transfer device, which transfers the component from the tool of the first press 10.1 into the tool of the second press 10.2 within maximally 4 seconds, preferably within maximally 3 seconds, is used between the two stations 10.1, 10.2.

In the second stage 10.2 of the press system, the component 2′ is then cooled down from a temperature in the range of approximately 580° C. to 500° C. to a temperature in the range of approx. 300° to 200° C., preferably to 200° C. within a period of approx. 5 to 6 seconds, and is cut in partial areas, if need be. The cooling rate in the second stage 10.2 lies approximately in the range of from 76 to 33.3 K/s and thus in turn considerably above the critical cooling rate of 27 K/s.

In the area which contacts the component area 2.2, in which a high stability is to be reached, the tools of the two press system stages 10.1, 10.2 are designed from a highly heat-conducting material. Contrary thereto, the tool area which contacts the component area 2.1 in which a cutting of the component 2′ is to take place subsequently, is formed from a material comprising a relatively low heat conductivity, so that the component area 2.1, which is still to be cut, is cooled down more slowly and thus reaches lower strength values.

Instead of using two individual hydraulic presses 10.1, 10.2 for hot forming the heated blanks 2, a double-ram press can also be used in the hot forming system according to the invention.

As is shown in the diagram in FIG. 8, the cooling rate during the hot forming (including the component transfer from the first stage 10.1 to the second stage 10.2 of the press system) as a whole lies clearly above the critical minimum cooling rate of 27 K/s. The curve identified with A_{PH} represents the cooling rate or the time-temperature curve, respectively, of the area 2.2 of the component 2′ transferred into the martensite state in the two stages of the press system 10, while the dotted curve, which is identified with Aₖᵣᵢₜ represents the critical minimum cooling rate of 27 K/s. The dashed curve A_{B} stands for the cooling rate of the area 2.1 of the component 2′, which is cut or punched, respectively, during or subsequent to the hot forming. It can be seen that the cooling in the edges 2.1 or in the areas of the component 2′, respectively, in which a hard cutting takes place, is carried out such that the cooling rate remains below 27 K/s (see FIG. 8).

The process control in the hot forming tools of the two press system stages 10.1, 10.2 is thus optimally divided and is matched with the time period for the transfer of the component 2′ from the first hot forming tool of the first press 10.1 to the hot forming tool of the second press 10.2.

In particular the hot forming tool of the first press 10.1, but also the hot forming or cooling tool, respectively, of the second press 10.2 can be provided with hydraulic or mechanical adjusting devices (not shown), which allow for a change of the distance between the tool halves, which can be moved relative to one another. Through this, an adaptation to sheet steels or blanks 2, respectively, comprising a different thickness is possible. The hydraulic or mechanical adjusting devices are preferably controlled automatically in response to the sheet intake. The measurement of the sheet intake or of the sheet thickness, respectively, is thereby carried out by means of suitable sensors or measuring systems, respectively.

At least one device 11.1 and/or 11.2 for cutting and/or punching the component 2′ follows the two-stage press system 10 in transport direction of the hot formed, press-hardened component 2′. By means of the one-stage or multi-stage cutting device 11.1, 11.2, a hard cutting of the areas, which are not transferred into the martensite state, in particular of the edges of the press-hardened formed components 2′, is carried out. For this purpose, the cutting device 11.1, 11.2 is equipped with suitable cutting and/or punching tools.

In the exemplary embodiment illustrated in FIG. 1, two cutting devices 11.1 and 11.2 are present, which are in the form of toggle presses. The hot forming system according to the invention can comprise a plurality of such cutting devices, wherein one or two cutting devices 11.1 and/or 11.2 should typically suffice. The press capacity of the respective toggle press 11.1, 11.2, is, for example, approx. 800 t or approx. 8 MN, respectively.

The transfer of the components from the press system 10 into the cutting device(s) 11.1, 11.2, in turn, takes place by means of one or a plurality of robots (not shown) or by means of other suitable, sufficiently quick transfer devices. During the cutting in the cutting device 11.1, 11.2, a further cooling of the component 2′ can take place, which can be in particular a natural or forced air cooling.

The number of strokes of the hot forming system according to the invention lies in the range of from 5 to 12 strokes/min, preferably in the range of from 7 to 12 strokes/min.

The exemplary embodiment of the hot forming system illustrated in FIG. 2 differs from the exemplary embodiment according to FIG. 1 in that a cooling device 12, by means of which the hot formed, press-hardened formed component 2′ is cooled down to room temperature RT by means of a liquid, preferably by means of oil or an emulsion, is arranged between the press system 10 and the cutting device 11.1. For this purpose, the cooling device 12 comprises a trough-shaped container for accommodating a liquid or emulsion bath, into which the respective component 2′ is dipped prior to the subsequent cutting in the cutting device 11.1, 11.2.

At the end of the hot forming system according to the invention, the finished component 2′ is removed from the cutting device or from the toggle press 11.1 or 11.2, respectively, and is stored in a storage or transport container, respectively.

1. A hot forming system for producing press-hardened formed components of sheet steel, comprising: a furnace by means of which sheet steel which is to be hot formed can be at least partially heated to austenitization temperature, and a press system for hot forming and press-hardening the sheet steel heated in the furnace, wherein a heating device is arranged upstream of the furnace by means of which the sheet steel can at least be partially heated to a temperature below the austenitization temperature, and the press system is embodied in a multi-stage manner, wherein a first part of the press system comprises at least a first tool for hot forming and for cooling the sheet steel heated in the furnace, and a subsequent part of the press system comprises at least a second tool for further cooling the hot formed sheet steel, and wherein the second tool further forms, cuts, punches, or performs a combination thereof on the hot formed sheet steel.

2. The hot forming system according to claim 1,
wherein the healing device comprises heating plates which can be moved relative to one another and which can be placed or pressed against a sheet steel which is arranged therebetween and which is to be heated.

3. The hot forming system according to claim 2,
wherein the heating device comprises a press, by means of which the heating plates can be hydraulically or mechanically pressed against a sheet steel which is arranged therebetween and which is to be heated.

4. The hot forming system according to claim 2,
wherein the heating plates are electrically or inductively heated heating plates.

5. The hot forming system according to claim 1,
wherein the heating device is embodied such that the sheet steel, which is to be hot formed, can be partially heated therein or can be heated to different degrees in partial areas.

6. The hot forming system according to claim 1,
wherein at least one mechanically or hydraulically driven cutting device for cutting, punching, or both cutting and punching the hot formed, press-hardened sheet steel is arranged downstream from the press system in a transport direction of the sheet steel.

7. The hot forming system according to claim 6,
wherein the cutting device is in the form of a toggle press which is provided with at least one cutting, punching, or combination cutting and punching tool.

8. The hot forming system according to claim 6,
wherein the cutting device comprises at least one cutting impact shock absorber.

9. The hot forming system according to claim 6,
wherein a cooling device is arranged between the press system and the cutting device, by means of which the hot formed, cooled sheet steel is further cooled down by means of a liquid.

10. The hot forming system according to claim 9,
wherein the cooling device comprises an immersion bath container.

11. The hot forming system according to claim 1,
wherein the furnace consists of a roller hearth furnace.

12. The hot forming system according to claim 1,
wherein the furnace is provided with at least one inductive heating device, at least one infrared radiator, or a combination thereof.

13. The hot forming system according to claim 1,
wherein a punching press for cutting blanks from a sheet steel strip is arranged upstream of the heating device.

14. The hot forming system according to claim 1,
wherein provision is made in each case for an automatically controlled transfer device, for transferring the respective sheet steel from the heating device to the furnace, from the furnace to the press system, from the press system to a cutting device arranged downstream, or a combination thereof.

15. The hot forming system according to claim 14,
wherein the transfer device is provided with a heating device for heating the sheet steel which is to be transferred.

16. The hot forming system according to claim 1,
wherein the tools comprise two halves and the press system is provided with hydraulic or mechanical adjusting devices which allow for a change of the closing distance between the tool halves which can be moved relative to one another.

17. The hot forming system according to claim 16,
wherein the hydraulic or mechanical adjusting devices are automatically controlled as a function of sheet intake, sheet thickness, or both and wherein sensors are provided for detecting the sheet intake, the sheet thickness, or both.

18. A method for producing press-hardened formed components of sheet steel, comprising: at least partially heating sheet steel in a furnace to austenitization temperature, hot forming the sheet steel by means of a press system and cooling down the hot formed sheet steel by means of a cooling device, wherein prior to heating in the furnace, the sheet steel is at least partially heated to a temperature below the austenitization temperature, by means of a heating device, and that cooling down of the hot formed sheet steel is carried out in multiple stages, wherein the sheet steel heated in the furnace is hot formed and cooled down in a first part of the press system and is afterwards further cooled down in a subsequent part of the press system, and wherein the hot formed sheet steel is additionally further formed, cut, punched, or a combination thereof in the subsequent part of the press system.

19. The method according to claim 18,
wherein the sheet steel is arranged, clamped, or both between heating plates in the heating device.

20. The method according to claim 18,
wherein the sheet steel is partially heated or heated to a different degree in partial areas in the heating device.

21. The method according to claim 18, wherein the sheet steel is supplied to the heating device as a cut blank and the blank is not heated directly, not tempered, or not heated directly and tempered at least in a partial area, in which cutting, punching, or both is carried out subsequently, such that the at least one partial area is not transferred into the austenitization state in response to the subsequent heating in the furnace.

22. The method according to claim 18, wherein the sheet steel is heated in the healing device such that, starting at a temperature of 500° C., a heating rate of 12 K/s is not exceeded.

23. The method according to claim 18, wherein prediffused manganese-boron sheet steel is used for producing the press-hardened formed components.

24. The method according to claim 18, wherein sheet steel heated in the furnace is cooled down to a temperature in the range from 700 to 500° C. in response to hot forming in the first part of the press system.

25. The method according to claim 18, wherein the hot formed sheet steel is cooled down to a temperature in the range from 300 to 200° C. in the subsequent part of the press system.

26. The method according to claim 18, wherein partial areas of the sheet steel are cooled down at different rates in the first part of the press system, in the subsequent part the press system, or in both parts of the press system and, wherein at least in a partial area in which cutting, punching, or both is carried out subsequently, cooling down is carried out at a lower cooling rate than in a partial area in which neither cutting nor punching is carried out subsequently.

27. The method according to claim 26,
wherein the partial area in which cutting, punching, or both is carried out subsequently, is cooled down at a cooling rate below 27 K/s.

28. The method according to claim 18, wherein the sheet steel in the first part of the press system is formed to a greater extent than in the subsequent part of the press system.

29. The method according to claim 18, wherein the hot formed sheet steel is calibrated in the subsequent part of the press system.

30. The method according to claim 18, wherein the sheet steel is cut, punched, or both after hot forming by means of at least one cutting device.

31. The method according to claim 30,
wherein the hot formed sheet steel is cooled to room temperature in a water, oil or emulsion bath after hot forming and prior to cutting or punching.

32. The method according to claim 18, wherein the sheet steel is transported from the heating device to the furnace, from the furnace to the press system, from the press system to a cutting device, which is arranged downstream, or a combination thereof as a cut blank, in each case by means of an automatic transfer device.
